(19) United States
(12) Patent Application Publication
(10) Pub. No.: US 2008/0029507 A1
(43) Pub. Date: Feb. 7, 2008

(54) Method and apparatus for attaching a membrane roof using an arm-held induction heating apparatus

(75) Inventors: John P. Barber, Dayton, OH (US); Antonios Challita, Bellbrook, OH (US)

Correspondence Address: Frederick H. Gribbell;FREDERICK H.GRIBBELL,LLC, Suite 120, 10250 Alliance Road, Cincinnati, OH, 45242, US

(73) Assignee: Nexicor LLC

(21) Appl. No.: 11/507,131

(22) Filed: Aug. 21, 2006

Related U.S. Application Data
(60) Provisional application No. 60/832,728, filed on Jul. 21, 2006.

(51) Int. Cl. H05B 6/10

(52) U.S. Cl. 219/633

(57) ABSTRACT

An improved induction heating apparatus is provided for attaching membrane roofs. A top membrane layer is attached to attachment disks that hold sheets of thermal insulation to the top of roof substrates. The heating apparatus emits a magnetic field that raises the temperature of the disks and a heat-activated adhesive on top of the disks which, after cooling, becomes adhered to the bottom surface of the top membrane layer. The disks in turn are attached via fasteners to the substrate portion of the roof structure. The apparatus includes a set of bottom guides that allow a user to find the attachment disks mechanically, without actually seeing those disks beneath the top membrane layer. A triple-racetrack coil provides improved positioning tolerance in all directions, for coil placement during a heating event. An optional temperature sensor can “test” the heating effect on the top membrane layer, during/after a heating event.

### CROSS-REFERENCE TO RELATED APPLICATIONS

The present application claims priority to provisional patent application Ser. No. 60/832,728, titled “METHOD AND APPARATUS FOR ATTACHING A MEMBRANE ROOF USING AN ARM-HELD INDUCTION HEATING APPARATUS,” filed on Jul. 21, 2006.

### TECHNICAL FIELD

The present invention relates generally to induction heating equipment and is particularly directed to an induction heating apparatus of the type which attaches membrane roofs. The invention is specifically disclosed as a method and apparatus used to attach a top membrane layer to attachment disks that hold sheets of thermal insulation to the top of roof structures. The apparatus includes a self-contained power supply and a controller that provides alternating current of an appropriate frequency to an induction “work” coil that emits a magnetic field, which is used to induce eddy currents in the metal attachment disks, thereby raising the temperature of those disks. The upper surface of the disks have a heat-activated adhesive that becomes adhered (by heating the disks) to the bottom surface of the top membrane layer, and after being allowed to cool, then attaches the top membrane layer to the disks, which in turn are attached via fasteners to the substrate portion of the roof structure. The apparatus includes a set of bottom guides that allow a user to find the attachment disks mechanically, without actually seeing those disks, which are beneath the top membrane layer. The apparatus allows a user to stand upright while operating the apparatus.

### BACKGROUND OF THE INVENTION

Induction heating devices have been available for use with membrane roofs in the past. One such device is described in U.S. Pat. No. 6,229,127. The induction heating device in this patent used four sensing coils with indicators to help the user find the correct position of the induction tool over one of the attachment disks that is to be heated by the induction coil of the tool. This conventional tool was fairly small in height, and the user had to generally be in a kneeling position to use it.

Another conventional heating device for use with membrane roofs is described in U.S. Pat. No. 4,743,332. This invention “pre-heats” the membrane roofing material, and has a rather large enclosure that sucks air through louvers to cool the electronics. Moreover, this device is a rolling device, and is not a hand-held or arm-held device.

### SUMMARY OF THE INVENTION

Accordingly, it is an advantage of the present invention to provide an induction heating tool used for membrane roofing in which the user can remain in a standing or walking position at all times while properly positioning the induction heating tool over one of the attachment disks.

It is another advantage of the present invention to provide an induction heating tool that is used to adhere an attachment disk to a membrane layer of a membrane roof structure, in which the induction heating tool provides a mechanical guide to readily allow the user to locate the attachment disks beneath the membrane layer.

It is yet another advantage of the present invention to provide an induction heating tool for use with a membrane roof in which the tool has an induction heating coil that is constructed in a triple racetrack coil configuration, and which allows for a greater tolerance in all directions for placement of the tool while heating an attachment disk that is positioned beneath the membrane layer.

It is a further advantage of the present invention to provide an induction heating tool for use with a membrane roof in which the tool has a heat spreader device positioned near the induction coil that assists in a more uniform thermal energy distribution, and which allows for a greater heat transfer rate away from the base of the tool that contains the induction coil.

It is still a further advantage of the present invention to provide an induction heating tool for use with a membrane roof in which the tool has the capability of being handled by a user's arm, in which some components are placed in a base or “bottom” portion on one end of a handle, while other components are placed on a “top” portion at the opposite end of the handle, thereby providing for a better weight distribution.

It is still another advantage of the present invention to provide an induction heating tool for use with a membrane roof in which the tool has a temperature sensor near the bottom of the base portion that contains the induction coil, and this temperature sensor can be used to “test” the effect of the magnetic field being generated by the induction coil to determine if the membrane layer of the roofing material has been sufficiently heated by use of the magnetic field.

It is still a further advantage of the present invention to provide an induction heating tool for use with a membrane roof in which the tool has an articulated joint between the handle and the base portion of the tool, thereby allowing the user to operate the tool at different angles between the handle and the membrane roof layer.

It is still a further advantage of the present invention to provide an induction heating tool for use on a membrane roof in which the induction heating tool is air-cooled by liberal use of heat sink elements, including multiple heat sink elements on the base structure of the tool which also contains the induction heating coil.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a method for operating an induction heating apparatus is provided, in which the method comprises the following steps: (a) providing a unitary induction heating apparatus, which comprises: (i) an electrical power supply, (ii) a controller, (iii) an induction coil, (iv) a base portion which includes a mechanical guide structure, and (v) a longitudinal member that is placed between a first portion and a second portion of said unitary induction heating apparatus, said longitudinal member including an attachment device; wherein: said first portion includes at least one of said electrical power supply and said controller, and said second portion includes at least one of said induction coil and said base portion; (b) temporarily attaching said induction heating apparatus to an arm of a human user, in which said attachment device of the longitudinal member is placed in physical communication with said human arm; (c) placing said human user with said attached induction heating apparatus atop a membrane roof structure under construction, said membrane roof structure including a lower substrate, a plurality of thermally insulative members, a plurality of attachment members, and an upper membrane structure, wherein: (i) said plurality of attachment members are at least partially electrically conductive, and (ii) a layer of thermally-activated adhesive material is affixed to an upper surface of said plurality of attachment members; wherein: said second portion extends at least somewhat downward toward said membrane roof structure under construction, and said first portion extends at least somewhat upward away from said membrane roof structure under construction; (d) placing a fastener portion of said plurality of attachment members through said plurality of thermally insulative members, and into said lower substrate, thereby attaching said plurality of thermally insulative members to said lower substrate; (e) placing said upper membrane structure atop said plurality of thermally insulative members, and atop said plurality of attachment members; (f) placing said base portion of the induction heating apparatus above said membrane surface, and mechanically locating at least one of said plurality of attachment members using said mechanical guide structure of said base portion, while said user of the induction heating apparatus operates in a standing position; and (g) energizing said electrical power supply and said induction coil, thereby emitting a magnetic field from said induction coil, raising a temperature of at least one of said plurality of attachment members, and thereby raising a temperature of said thermally-activated adhesive material such that said thermally-activated adhesive material adheres to a bottom surface of said upper membrane structure, while said user of the induction heating apparatus remains in a standing position.

In accordance with another aspect of the present invention, an induction heating apparatus is provided, which comprises: (a) a lower base portion, (b) an upper body portion, and (c) a handle portion located therebetween; (d) an electrical power supply and a controller; (e) a manually-operable actuation device located in said handle portion; (f) an attachment device located in said handle portion for releasably attaching said handle portion to an arm of a human user; (g) an induction coil located in said base portion; and (h) a mechanical guide structure located along a bottom surface of said base portion, said mechanical guide structure being of a size and shape to assist in positioning said induction heating apparatus proximal to an attachment member used in a membrane roof structure; wherein said upper body portion includes at least one of said electrical power supply and said controller.

In accordance with yet another aspect of the present invention, an induction heating apparatus is provided, which comprises: (a) a lower base portion, (b) an upper body portion, and (c) a handle portion located therebetween; (d) an electrical power supply and a controller, at least one of which is located in said upper body portion; (e) a manually-operable actuation device located in said handle portion; (f) an induction coil located in said lower base portion; and (g) a plurality of heat sink elements located on a surface of said lower base portion.

In accordance with still another aspect of the present invention, an induction heating apparatus is provided, which comprises: (a) a lower base portion, (b) an upper body portion, and (c) a handle portion located therebetween; (d) an electrical power supply and a controller, at least one of which is located in said upper body portion; (e) a manually-operable actuation device located in said handle portion; (f) an induction coil located in said lower base portion; and (g) at least one temperature sensor located near a bottom area of said lower base portion.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a perspective view from the front, side, and above showing an induction heating tool for use with membrane roofing, according to the principles of the present invention.

FIG. 2 is a perspective view, from above and behind, of the tool of FIG. 1, showing the handle with display, arm cuff, electrical housing, and the top of the base portion of the tool.

FIG. 3 is a side elevational view of the right side of a top portion of the tool of FIG. 1.

FIG. 4 is a side elevational view of the left side of a top portion of the tool of FIG. 1.

FIG. 5 is a top plan view of the base portion of the induction heating tool of FIG. 1.

FIG. 6 is an elevational view from the rear of the base portion of the induction heating tool of FIG. 1.

FIG. 7 is a section view of the base portion of the induction heating tool of FIG. 1, taken along the section line 7-7 of FIG. 6.

FIG. 8 is a perspective view of the induction heating tool of FIG. 1, showing the tool from a bottom angle and showing details of the bottom portions of the base.

FIG. 9 is an exploded view of the base portion of the induction heating tool of FIG. 1.

FIG. 10 is a perspective view showing a user using the induction heating tool of FIG. 1 on top of a membrane roof.

FIG. 11 is a front elevational view of the induction heating tool of FIG. 1, as used on a membrane roof that is shown in partial cross-section.

FIG. 12 is a perspective view of an alternative embodiment of the induction heating tool of FIG. 1, showing the tool from a bottom angle and showing details of the bottom portions of the base, in which there is no mechanical guide structure.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

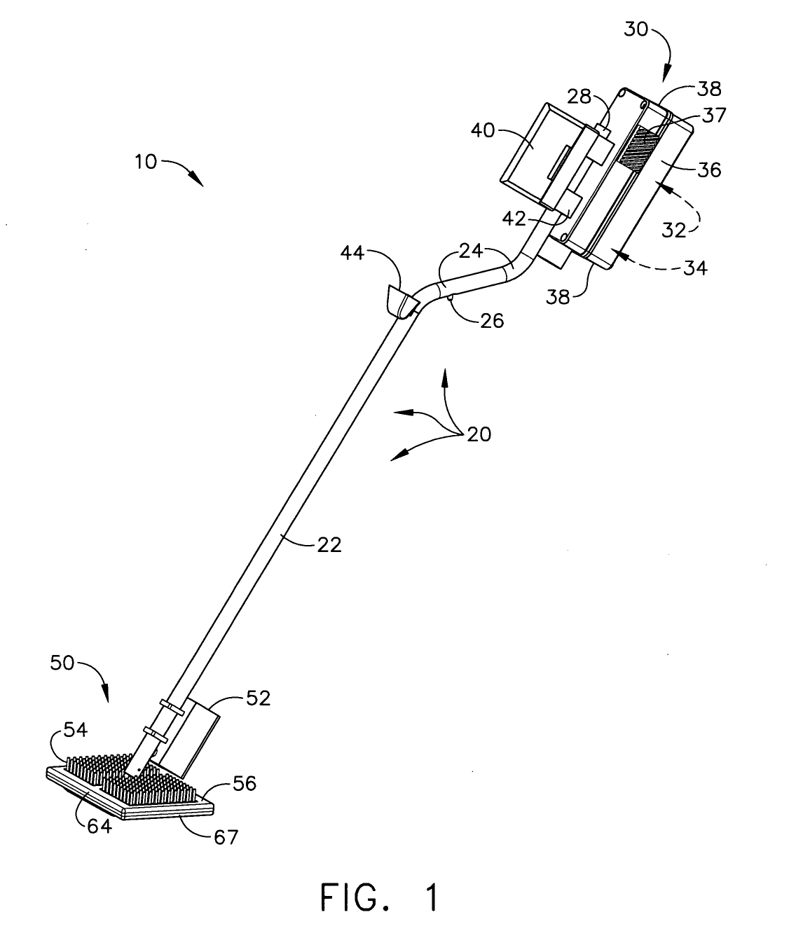

Referring now to FIG. 1, an induction heating tool generally designated by the reference numeral 10 is illustrated, having a handle portion 20, an electrical housing 30, and a base portion 50. Induction tool 10 is made to be portable, and is generally used in an upright position, in which the base portion 50 is the lowermost portion, and the handle portion 20 connects the base portion 50 to the electrical housing 30 neat the top of the unit. The electrical housing 30 contains several electrical components, typically including a controller and power supply 32, and a coil driver circuit 34. In general, the type of controller and power supply that would be suitable for the induction tool 10 are described in U.S. Pat. No. 6,509,555.

Handle portion 20 includes a curved elongated portion 24, a middle extension portion 22, and an actuation button 26. In general, the actuation button 26 would consist of an electrical pushbutton switch, or some other type of trigger structure that will provide an “on” or “start” signal to the controller that resides in the electrical housing 30. The handle extends to a top portion 28, which has attachment members (e.g., mounting brackets) 42 that connect to the electrical housing 30, and also to an arm cuff 40.

The electrical housing 30 includes a power supply typically mounted on a printed circuit board 32 and a work coil drive (or interface) circuit typically mounted on a printed circuit board 34, in which the components of these two circuit boards 32 and 34 are typically electrically connected to one another, as needed. The power supply PC board 32 may have a microprocessor or microcontroller mounted thereon, or such microprocessor or microcontroller could instead be mounted to the work coil interface PC board 34, if desired. A source of electrical power would be needed, and could be in the form of an electrical connector or a built-in umbilical cord (not shown on FIG. 1), or perhaps a battery pack could be installed on the tool, if desired. The housing 30 includes top and bottom covers or surfaces 30, and side covers or surfaces 36, as illustrated in FIG. 1. Some of the covers may have a set of heat sinks 37 thereon.

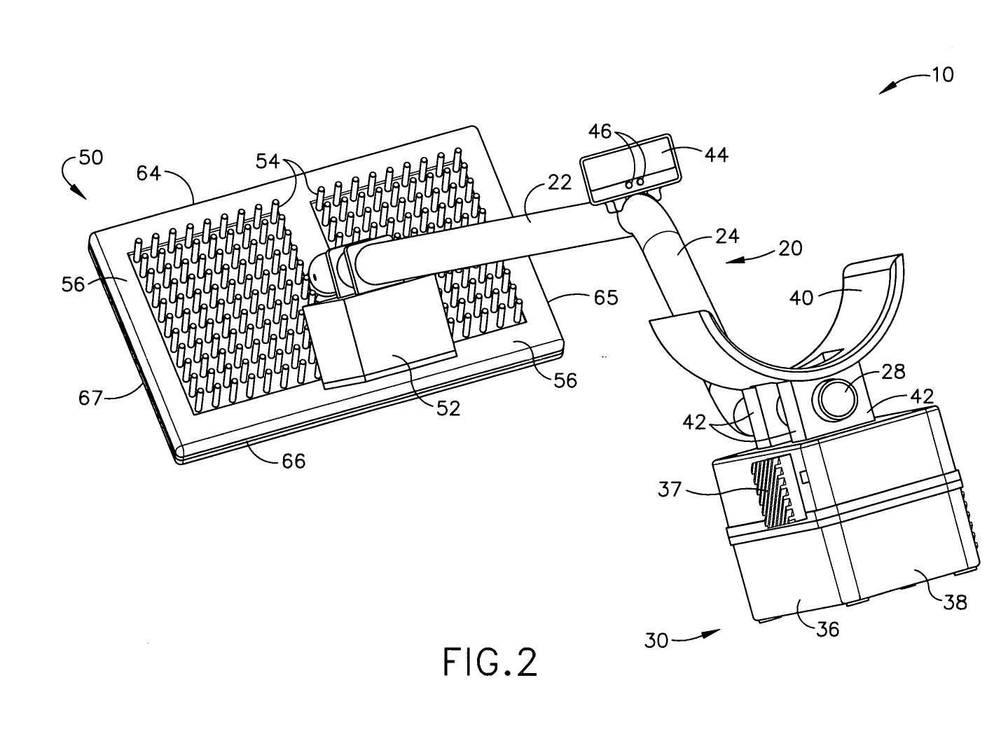

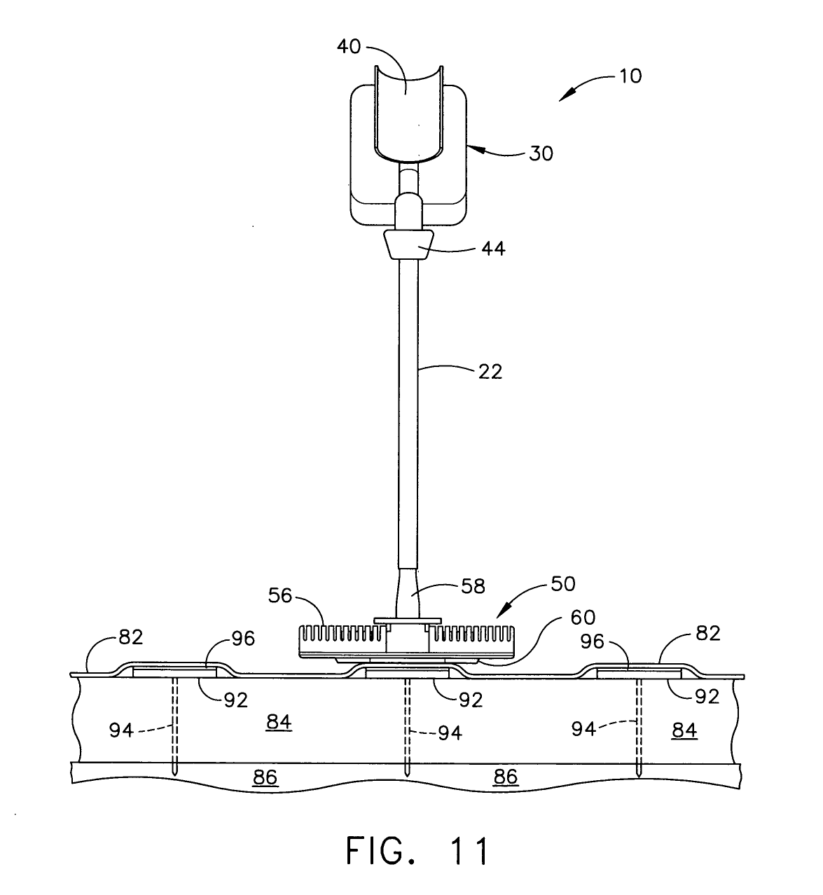

The handle portion 20 near its top end portion 28 is attached to a mounting structure 42 which, in the illustrated embodiment, comprises a pair of mounting brackets that connect to the electrical housing 30, and also to the arm cuff 40. This arrangement can be seen in greater detail in FIG. 2. Near the junction of the straight portion 22 and the curved portion 24 of handle 20 is a display 44, which is located in a position for easy viewing by a user when the tool 10 is in operation. This is better illustrated in FIG. 2, and in FIG. 10.

The configuration of the handle 20 allows for superior weight distribution when the tool 10 is used and held in a user's arm. The handle 20 can have an adjustable length feature, in which the straight portion 22 can have a variable length. The attachment point 58 between the handle and the base portion 50 can be articulated, so the handle portion 22 and the base 50 can work at a variable angle.

There are two user-actuated buttons 46 that are located on the display 44. This can best be seen in FIG. 2. The user can actuate these buttons or “controls” 46 to adjust the power setting that is to be generated by the induction coil 68. In most circumstances, the user would want to adjust the power setting for different ambient temperature conditions when operating the tool on a membrane roof environment. In many commercial situations, the artisans that are constructing a membrane roof structure will take a temperature reading four or more times a day, and can adjust the tool's power output generations by use of the user controls 46. In general, as the roof temperature increases (during the morning), the output power setting can be decreased.

Base portion 50 includes a top cover 56 and a bottom cover 62, and includes an attachment point structure 58 where the bottom end of the handle 22 is attached thereto. The side edges of the base are viewed in several of the figures, having the reference numerals 64, 65, 66, and 67.

Base portion 50 includes electrical conductors and other mounting hardware to support an induction coil 68 that is not visible on FIG. 1. This induction coil 68 is the main “work coil” that emits a magnetic field for heating spaced-apart objects when the tool 10 is utilized. Base portion 50 also includes a number of heat sink elements 54 which, in the illustrated embodiment of FIG. 1, comprise multiple pin heat sinks that are mounted in a vertical direction. Since the work coil tends to produce large amounts of thermal energy, the numerous heat sink elements 54 are arranged to as to remove that thermal energy from the base portion 50 as efficiently as possible, for example, by being mounted very close in proximity to the work coil that is producing this thermal energy. In FIG. 1, the heat sink elements 54 are pin-style heat sinks, and are mounted on the top or upper portion of the base 50.

Referring now to FIG. 2, the induction heating tool 10 is again illustrated in a perspective view, this time from almost “straight” above the top handle portion. The electrical housing 30 has side covers 36 and a top cover 38, easily seen in FIG. 2. The side covers can have heat sinks 37 to allow ambient air to help cool the internal components of the electrical housing 30. In a preferred mode of the invention, the housing 30 would be of weatherproof construction, so that that tool 10 could be used in the rain, or snow, etc.

The heat sinks 37 can be placed at various different locations around the housing 30; multiple locations could be used (as illustrated), or all the heat sinks 37 could be placed in a single area of the housing. Typically, the heat sinks would be placed relatively near the internal components that are generating the heat within housing 30; in general, the heat sinks 37 would be in thermal contact with those heat-generating components (such as power supply components). Furthermore, it is usually best if the heat sinks are located at positions where they are not likely to come into contact with the user's hand or arm during use, for example.

The top portion of the base 50 includes a cover 56, that can have large spaced-apart openings (as in the illustrated embodiment) to allow air to be exchanged between the heat sink elements 54 and the ambient atmosphere around the tool at the base 50 (see FIG. 5). An alternative cover design could more completely enclose the heat sink elements 54, while still having openings or slots to allow air to be exchanged between the heat sink elements 54 and the ambient atmosphere around the tool's base 50.

When viewing FIG. 2, the display 44 is readily apparent, which can contain information that will be important to the user of tool 10, such as the present output power setting. The arm cuff 40 is also seen as being attached to the attachment members 42, which in turn are attached to the top portion 28 of the handle 20, and also to the side of the electrical housing 30.

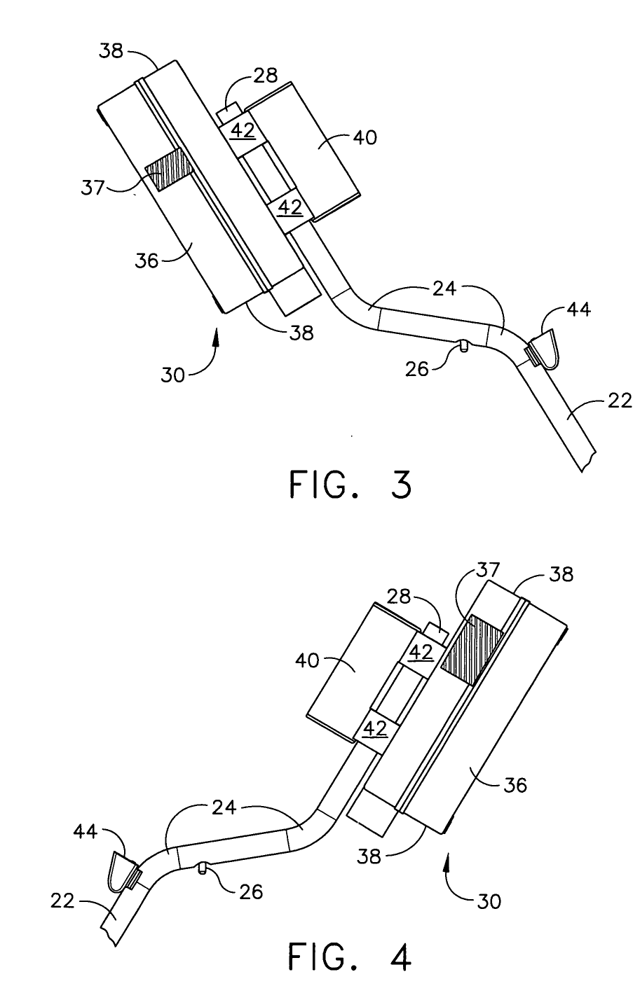

FIGS. 3 and 4 are side elevational views of the upper portion of the tool, showing a portion of the straight handle 22, the curved portion of the handle 24, and the top portion of the handle 28. The display 44 is also readily viewable, and the electrical housing 30 is illustrated. The arm cuff 40 is illustrated as being attached to the attachment members or brackets 42, along with the housing 30.

If desired, the side covers 36 of the electrical housing 30 can include multiple fin heat sinks 37 on either side, or on both sides, of the covers 36. This arrangement can provide additional cooling of the electronics. As noted above, the location(s) of the heat sinks can be centralized or dispersed, depending on certain system design choices, such as the positions of the internal heat-generating components.

Referring now to FIG. 5, the base portion 50 is viewed from above, which illustrates the top cover 56, the multiple pin heat sink elements 54, and the attachment point 58 where the handle makes connection to the base portion 50. The attachment point 58 can be swivelable, and thus act as a pivot point, such that the handle 22 can swivel at a variable angle with respect to the top portion of the base 50, if desired. This can be helpful to the user when applying the base portion 50 to the upper portion of a membrane roof structure, when it is time to heat one of the attachment disks of the membrane roof structure. The outer edges of the base portion 50 are also illustrated in FIG. 5, in which the longitudinal outer edges are designated by the reference numerals 64 and 66, and the transverse edges are designated by the reference numerals 65 and 67.

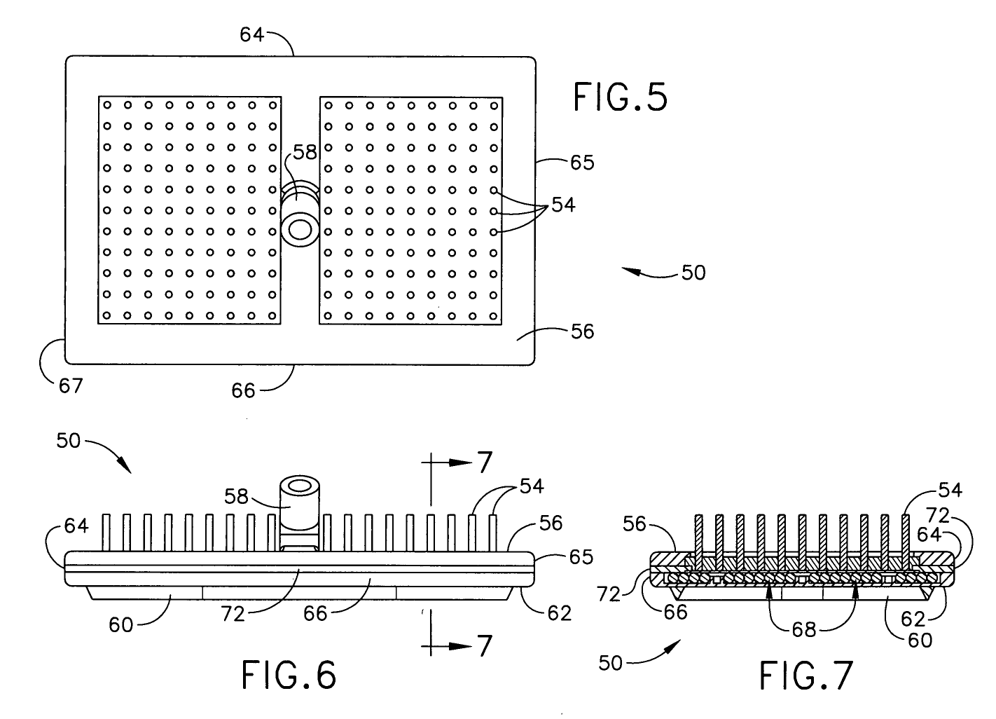

Referring now to FIG. 6, the base portion 50 is depicted in an elevational view, showing the rear edge or surface 66, as well as the top cover 56 and the bottom cover 62. Protruding from the bottom cover 62 is an oval-shaped mechanical guide member 60. This will be illustrated in greater detail in the following figures. The pin heat sink elements 54 are depicted in FIG. 6, as well as the attachment point 58.

FIG. 7 is a section view taken along the lines 7-7 of FIG. 6. The pin heat sink elements 54 are seen as extending from an interior portion of the base portion 50 and protruding upward and past the upper or top base cover 56. The mechanical guide member 60 can be seen as protruding from the bottom cover 62 of the base portion 50. The induction coil structure 68 is seen in cross-section, showing multiple windings and multiple turns of this coil 68. Induction coil 68 will be illustrated in greater detail in the following views. A spacer 72 is positioned between the top base cover 56 and the bottom base cover 62.

Toward the bottom portion of the straight handle 22 is a small enclosure, generally designated by the reference numeral 52. This enclosure can contain power capacitors that will share reactive current with the induction coil 68 that is contained within the base portion 50. By locating these power capacitors 52 in close physical proximity to the induction coil 68, the size of the electrical conductors running through most of the handle 20 can be much smaller than if the power capacitors were located in the electrical enclosure 30. This is not to say that the power capacitors could not be physically located within the electrical enclosure 30, if desired. In that situation, the size of the electrical conductors between the electrical closure 30 and the induction coil 68 (contained within the base portion 50) would of necessity need to be larger, because they would be carrying not only the working load current producing the “work” needed to provide a magnetic field of the induction coil, but they would also be carrying the reactive current that is also provided to the induction coil.

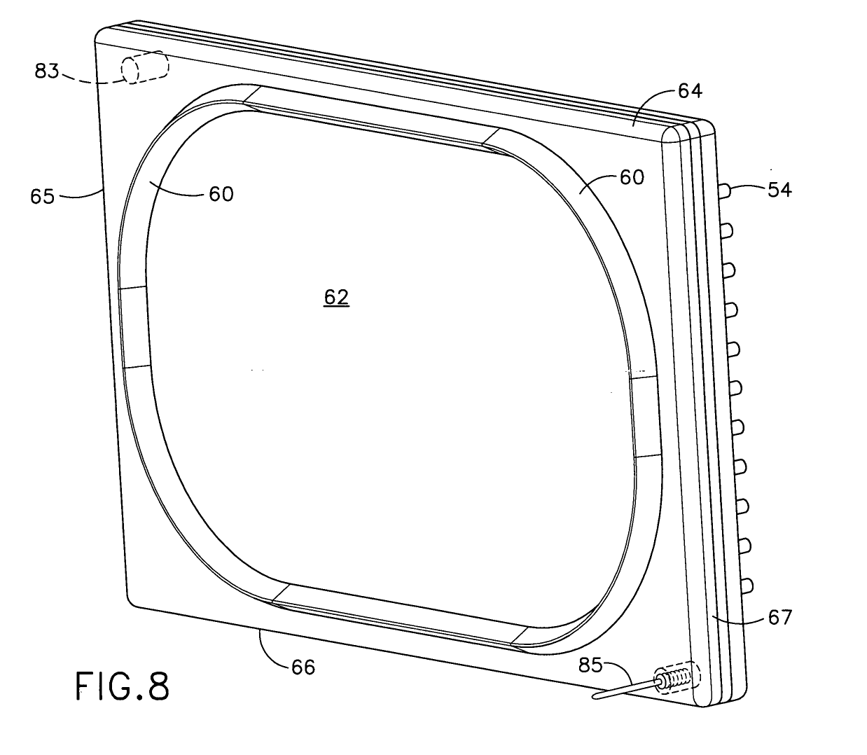

Referring now to FIG. 8, the base portion 50 is viewed from below, in which the induction heating coil 68 is hidden from view in this figure, since it is hidden by a bottom planar cover 62. The outer longitudinal edges at 64 and 66 are visible. An oval guide structure or “rail” 60 protrudes from the bottom of the planar cover 62 of base portion 50. If desired, the guide 60 could run the entire longitudinal length of the base portion 50, or it could run only a portion of the distance from one end to the other along the longitudinal dimension of the base portion 50. The outer transverse edges are depicted at 65 and 67.

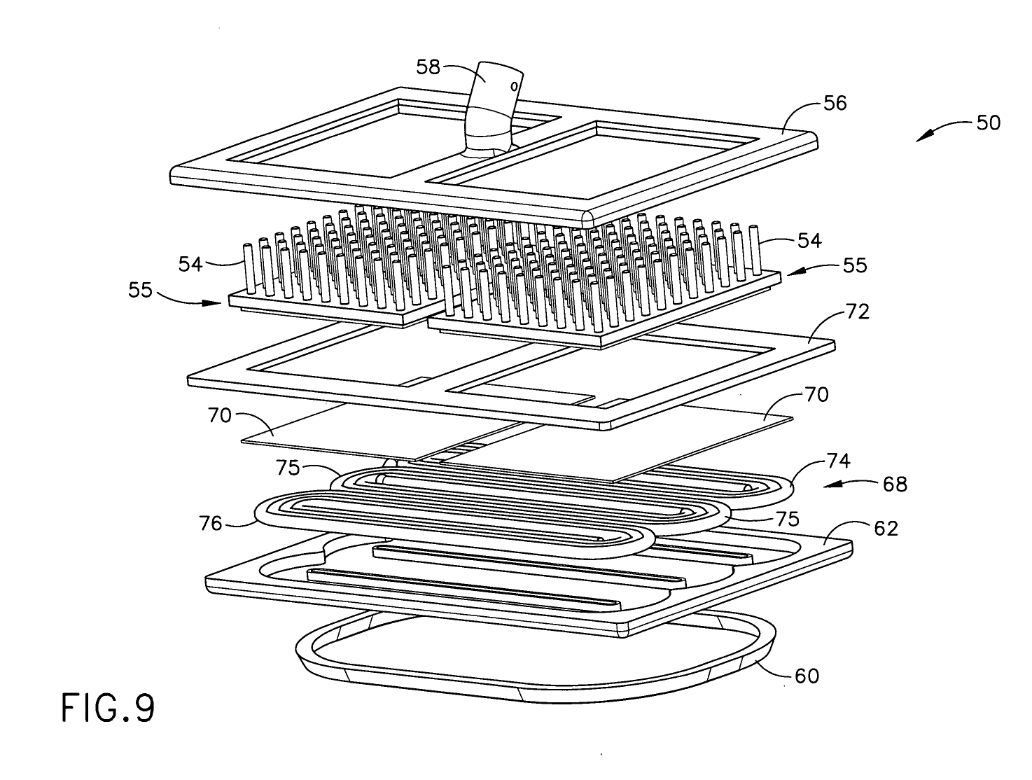

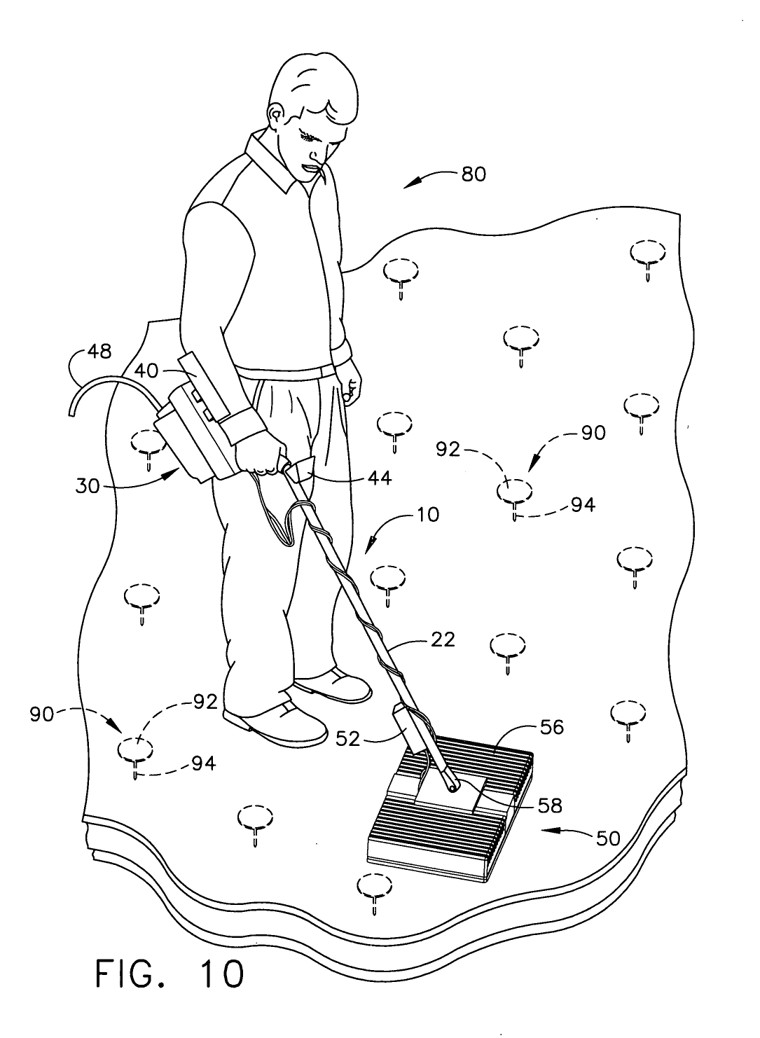

Referring now to FIG. 9, the base portion 50 is depicted in an exploded view, and its uppermost part is the top cover 56, which also has the attachment point 58 attached thereto. Beneath the top cover 56 is a sub-assembly, designated by the reference numeral 55, that holds a large number of pin heat sink elements 54. In FIG. 9, there are two such sub-assemblies 55, one on each side of the transverse centerline of the base 50. Beneath the sub-assemblies 55 is a spacer structure 72 which holds the sub-assemblies 55 in position.

Between the spacer 72 and the induction coil 68 is a “heat spreader” structure generally designated by the reference numeral 70. This heat spreader construction is used to more uniformly distribute the thermal energy being produced in the induction coil 68, so that thermal energy dissipation (i.e., heat transfer) will be maximized. In the illustrated embodiment of FIG. 9, there are two separate sheets of the heat spreader structure 70, which are in close proximity to the windings of the induction coil 68. If desired, the heat spreader could be in physical contact with the induction coil 68, to further maximize the thermal energy transfer (via conduction) away from the coil through the base portion 50. The construction of this heat spreader should be one that is a thermal conductor, but also an electrical insulator. Certain ceramics can be used as this heat spreader device, and in a preferred construction of the present invention, the heat spreader portions 70 can be made of aluminum nitride.

At the bottommost portion of the base 50 is the oval mechanical guide 60, and above that (and attached thereto) is the bottom cover 62 of the base structure 50. Just above that is the induction coil structure 68. In the illustrated embodiment of FIG. 9, induction coil 68 actually comprises three individual “racetrack” coil structures, designated by the reference numerals 74, 75, and 76.

The triple racetrack coil 68 is made of three oval-shaped windings, and these windings can be electrically connected in series, if desired, or they can be connected in three parallel windings. In any case of the configuration illustrated in FIG. 9, each of the windings 74, 75, and 76 has multiple turns.

The guide structure 60 is provided to assist a user in locating one of a plurality of attachment disks that are used in membrane roof structures. This type of roof structure will be described below, mainly with reference to FIGS. 10 and 11. The guide structure 60 is sometimes referred to herein as a “runner” or “rail.”

Note that the base top cover 56 includes large square or rectangular openings in the illustrated embodiment of FIG. 9, which allow the heat sink elements 54 to be directly exposed to ambient air. In an alternative embodiment, top cover 56 could be raised over the uppermost extent of these pin-style heat sink elements 54, to mechanically protect them. In this alternative embodiment, the top cover 56 could have multiple openings or slots to allow ambient air to be exchanged with the heat sink elements 54, as illustrated in FIGS. 10 and 11.

Referring now to FIG. 11, the induction heating tool 10 is illustrated in a front elevational view. In this view, the longitudinal portion of guide (or runner) 60 is seen as protruding from the bottom surface 62 of the base portion 50. Some of the major elements of a membrane roof structure are depicted on FIG. 11.

In general, a membrane roof structure includes a top membrane layer 82 that may comprise some type of rubber or plastic compound. The main purpose of the membrane 82 is to prevent water from entering the building for which this roof is used. A layer of thermally insulative sheets is provided at 84, which sit upon a substrate 86. The sheets 84 are typically held to the substrate 86 by a set of attachment disks 92 which have some type of fastener 94 mounted therethrough. The attachment disk 92 could be permanently attached to its fastener 94, if desired.

In typical membrane roofs, the attachment disks 92 are circular, and have a center opening through which a relatively long screw 94 is placed. The screw is then pushed and rotated into the substrate 86, thereby holding the attachment disks in place, while also holding the insulative sheets 84 in place. In some conventional membrane roof structures, the disks 92 are coated on site with some type of liquid or gelled adhesive, and then the membrane layer is rolled over the top of them while the adhesive cures. When the adhesive cures, the membrane layer 82 becomes attached to those top surfaces of the disks. In other conventional membrane roofs, the fastener 94 is driven through the membrane layer itself, which can cause leakage problems in the top of the roof unless these structures are sealed properly.

In the present invention, the fasteners 94 are only used to run through the center opening in the attachment disk 92, and then through the thermal insulative sheets 84, and finally into the substrate 86. These fasteners 94 do not run through the top membrane layer 82. However, the membrane layer 82 must somehow be attached either to the thermally insulative sheets 84 or to the attachment disks 92. In the present invention, the attachment disks 92 are coated (usually at the factory) with a thermally-activated adhesive material. This adhesive material remains inactive until after the membrane material is rolled across the roof. The induction tool 10 is then brought in close proximity to one of the attachment disks 92, and then the tool is actuated. When that occurs, a magnetic field is emitted by the induction coil 68 (not seen in FIG. 11) which creates eddy currents in the electrically conductive portions of the disks 92.

In general, the disks 92 comprise a metallic substance (e.g., aluminum or steel), which would tend to be electrically conductive. When the eddy currents are generated, the disks 92 are raised in temperature to a point where the top adhesive 96 becomes active, and generally would melt. The adhesive 96 will then adhere to the bottom surface of the membrane layer 82. When the induction tool 10 is de-activated, the entire system cools down and the adhesive 96 remains adhered to the bottom surface of the membrane layer 82, thereby “permanently” mounting the membrane layer 82 onto the tops of the attachment disks 92.

Referring now to FIG. 10, a user 80 is depicted as walking along with the induction heating tool 10, and as the user finds one of the attachment disks 92, the user will actuate the induction heating tool 10. In FIG. 10, each of the attachment disks 92 in combination with one of the fasteners 94 is generally designated by the reference numeral 90. The user 80 first needs to find the attachment structures 90, and then needs to be relatively accurate in placement of the induction heating tool 10 when attempting to activate the adhesive 96 on the top of the attachment disks 92. The present invention has an aspect that helps the user 80 locate the attachment structures 90, as described immediately below.

As depicted in FIG. 2, it can be seen that induction heating tool 10 has a base structure that appears wider in one dimension (its width) than in its narrower dimension. As discussed above, these dimensions are also referred to herein as the “longitudinal” dimension and the “transverse” dimension. FIG. 5 illustrates an example of proportional dimensions for the base portion 50. Each of the individual racetrack coil portions are essentially oval-shaped, rather than circular-shaped; with three of them arranged in a manner as depicted in FIG. 9, the overall shape of the base portion 50 exhibits somewhat of a square shape (as seen in FIG. 5).

For appropriate heating of one of the attachment structures 90, it is best if the base portion 50 is positioned directly over the center of the circular attachment disk 92. However, there is some tolerance with respect to how accurate the user 80 must be in positioning the induction heating tool 10 over the circular attachment disk 92. The longitudinal tolerance is actually fairly large, and can be as much as one inch in either direction (e.g., ±1 inch). A typical user will find this to be quite easily accomplished when positioning the induction heating tool 10. This longitudinal dimension would be perceived by the user 80 as a side-to-side dimension, which means that the user 80 would perceive this as either moving the tool to the left or to the right when positioning tool 10 over one of the attachment structures 90. In other words, the operational positioning tolerance of this tool is now improved in virtually all horizontal directions, including the orthogonal directions that are substantially perpendicular to one another, which are referred to in the discussed below as the transverse and longitudinal directions (or dimensions).

In earlier designs of membrane roof induction tools by the same inventors, the transverse dimension has been somewhat more difficult to position, since the oval-shaped coil 68 is narrower in this transverse dimension. The relative size of the coil in the transverse direction is designed with a specific diameter in mind for the attachment disk 92, to achieve superior heating of the attachment disk 92 by the magnetic field emitted by the induction coil (or “work coil”) 68. From the user's perspective, this positioning direction would be in a forward or backward direction for moving the induction heating tool 10.

However, in the present invention the use of the triple racetrack coil provides a better (improved) tolerance in every direction, both in the transverse and in the longitudinal directions with regard to placement of the induction coil over the attachment disk 92. If, for example, a double racetrack coil was used in the induction tool of the present invention, the transverse tolerance might be about plus or minus one quarter of an inch; in a similar sized induction coil and base sub-assembly, the use of the triple racetrack coil can now allow a positioning tolerance of about plus or minus one inch in every direction (including the transverse direction). An example of the above-noted double racetrack design is disclosed in a co-pending patent application filed by the same inventors, Ser. No. 11/093,767, filed on Mar. 20, 2005, under the title “METHOD AND APPARATUS FOR ATTACHING A MEMBRANE ROOF USING INDUCTION HEATING OF A SUSCEPTOR.”

The guide rail 60 is the first aspect of the present invention that aids the user 80 in positioning the tool 10 in its proper location over one of the attachment disks 92. When the user is moving the tool 10 along the top of the membrane roof, the “front” longitudinal member of guide rail will “bump” into a raised portion of the membrane roof, which means that the user has physically found one of the attachment structures 90, since it is somewhat raised above the thermally insulative sheets 84. (See FIG. 11 for this configuration.) User 80 can then either tilt the induction heating tool 10 a little to clear the front edge of the attachment disks 92, or actually lift the tool 10, if desired. Then the user 80 will move the induction heating tool 10 a little farther forward until the “rear” longitudinal member of guide rail “bumps” against the attachment disk 92. When this has occurred, induction heating tool 10 is approximately in the correct heating position.

It will be understood that the guide structure 60 could have a shape that is not necessarily oval, while still performing the function of acting as a mechanical locating device for finding the attachment disks 92. Alternatively, a square shape or a more rectangular shape could be used, or perhaps a circular shape, if desired. However, one advantage of the oval shape is that it eliminates relatively sharp corners that might snag or tear the membrane layer (as opposed to a square or rectangular shape exhibiting right angles at the corners).

In an exemplary embodiment of the induction heating tool of the present invention, the distance between the inner dimensions of the two longitudinal members of guide rail 60 is somewhat larger than the outer diameter of one of the attachment disks 92. This is to allow some extra room to allow the tool 10 to be placed over an attachment disk 92, while also allowing for the space taken by the membrane layer 82. Since there is some extra “play” between the two longitudinal members of guide rail 60, the induction heating tool 10 can still be more accurately positioned for improved heating results.

In one exemplary embodiment of the induction heating tool of the present invention, a preregulator circuit will ramp the buck output voltage to about fifty volts DC, to power an output oscillator which drives the work coil 68. In this mode, the magnetic field being emitted by the work coil 68 is at the reduced “low energy” state, so inductive heating would be minimal. The microprocessor or microcontroller will sense the output of the rectified and filtered sense signal, referred to as V_{OUT}. During this stage of the operation, the induction heating tool 10 can be moved slowly forward and backward until the V_{OUT} voltage becomes substantially zero or becomes within a predetermined range, as discussed above. When that occurs, the controller will activate the indicating device (i.e., a visual or a tactile feedback, for example), which indicates that the VOUT voltage is at an appropriate magnitude, so that the user can be assured that the induction heating (work) coil 68 has substantially become centered over the attachment disk 92. When that occurs, the user can actuate the tool to appropriately heat the attachment disk 92.

When the base portion 50 of tool 10 is at (or near) the center of a disk 92, then the voltage magnitude for V_{OUT} will be at (or near) a minimum value, which the microcontroller will interpret as being within an appropriate heating location for the base portion 50 of tool 10 (i.e., with respect to its position near the attachment disk 92). In an exemplary embodiment, a certain tolerance will be allowed as part of a threshold test, when inspecting or sampling actual voltage magnitude of V_{OUT} (i.e., while looking for the actual minimum voltage magnitude). This threshold test could involve a predetermined “static” value, if desired, or it could be a dynamic value that is determined or modified by the microcontroller during run time (i.e., during actual operation of the tool 10). Certainly variations of this circuit and its operating logic could be utilized while remaining within the teachings of the present invention.

The present invention essentially provides a “locator” by use of the guide rails which are mechanical protrusions from the bottom base structure of the tool. A user typically will become adept at using the mechanical guide feature as the “locator” by practice, when the guide rail is moved to a location over the position of one of the attachment disks 92. At the same time, many users will become adept at using the induction heating apparatus of the present invention entirely without the assistance of the mechanical guide feature.

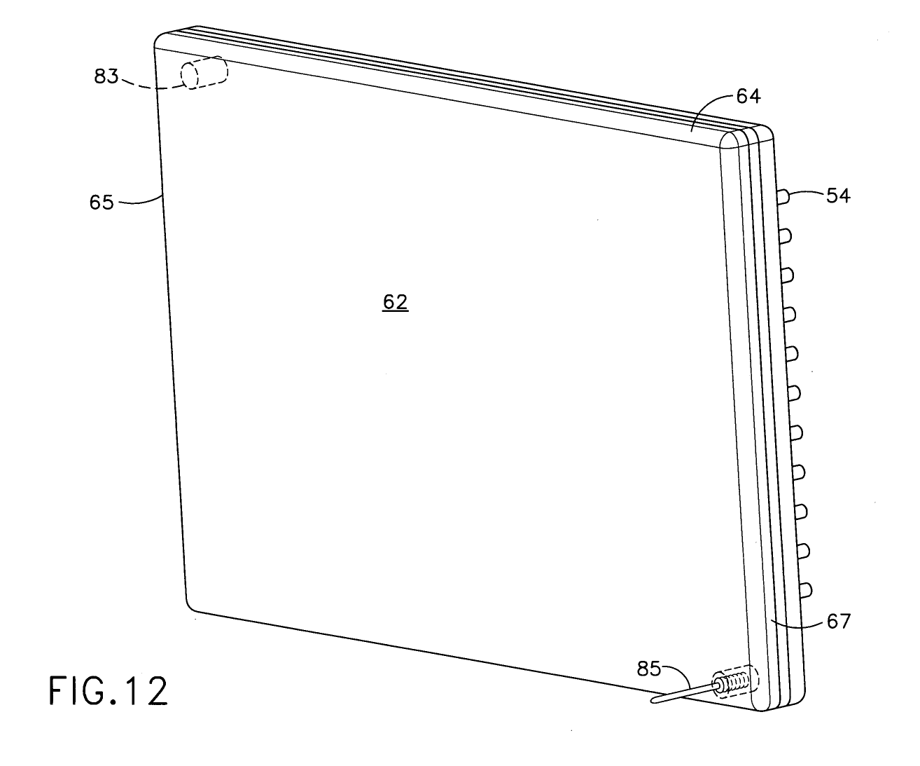

If a user desires to use the present invention without the mechanical guide feature 60, then the induction heating tool can be provided without that guide. In this alternative embodiment, the bottom of the base portion would have the appearance as depicted in FIG. 12. In FIG. 12, the base portion is viewed from below, in which the bottom surface or cover 62 is substantially planar, and there is no mechanical guide structure protruding from the bottom of the planar cover 62. The induction heating coil 68 is again hidden from view by this bottom planar cover 62. The outer longitudinal edges at 64 and 66 are visible, and the outer transverse edges are depicted at 65 and 67.

Another way of utilizing the present invention is to “test” the effect of the magnetic field on the membrane structure as the tool 10 is being used in real time. In one methodology, a temperature sensor could be placed in the base portion 50 in the bottom cover 62, preferably near one of the corners. Of course the attachment disk temperature will be raised due to the magnetic field, and such a temperature sensor can be used to determine whether or not the membrane structure of the roof has been raised to a sufficient temperature to ensure a good seal to the attachment disk 92.

Such a temperature sensor could be positioned within the base portion 50 as, for example, the temperature sensor 83 illustrated on FIG. 8, which is flush with the bottom surface of the bottom cover 62. Such a non-contact sensor could work on an infrared signature principle, for example.

An alternative temperature sensor type could be a “contact” sensor, such as the temperature sensor designated at 85 on FIG. 8. This contact sensor would actually be contained within the base portion 50, but would have a spring-loaded probe that protrudes downward and makes contact with the upper surface of the membrane roof. The temperature could be transmitted through the probe portion and make physical contact with a temperature sensor of various types, by designer choice. Note that a single tool 10 would typically not need both temperature sensors 83 and 85, illustrated on FIG. 8.

By use of self-contained temperature sensors, the induction-heating tool 10 of the present invention can become “fully automatic,” in that its output power could be automatically adjusted by the microcontroller, depending on the ambient air temperature at the start of a heating event. This could eliminate the need for a user to take periodic temperature readings, and then manually adjust the output power of the tool.

One important aspect of the present invention is the fact that the user 80 can use the induction heating tool 10 while always remaining in a standing position. Some of the conventional induction heaters used for membrane roofing had small location indicators that required the user to be in a kneeling position to see the indicators while attempting to correctly position the tool over one of the attachment disks. The present invention eliminates this awkward mode of operation, by allowing the user to quickly move the tool along the top of the membrane roof and mechanically locate the attachment disk. Once the attachment disk has been located, the user then lifts or tilts the tool so that the mechanical positioning guide will fit over the leading edge of the attachment disk, and then the tool can be further slid along the membrane until the work coil is essentially directly above the circular attachment disk. If a more fine positioning is desirable, then the electrical positioning sensor and indicator can then be utilized by the user. In all cases, the user never needs to leave the standing or walking upright position.

Another aspect of the present invention is that the work coil is suitably cooled by heat sinks that are directly attached to the base portion of the tool. This is an improvement over some of the conventional tools that required water cooling or forced air cooling. While certain aspects of the present invention could be used with a liquid cooled or an air cooled induction coil, in an exemplary embodiment of the present invention there are no liquid cooling pipes or tubes, and there is no fan or other type of forced-air cooling.

In many commercial applications of the present invention, the tool 10 will be powered by line voltage, using an extension cord that can plug into the electrical housing 30. Alternatively, the tool could be battery powered, by use of batteries either located within or adjacent to the electrical housing 30, or by the user wearing a backpack that holds the batteries. If a backpack is used, then a short power cord would be run between the backpack and the electrical housing 30. On FIG. 10, the power cord is designated by the reference numeral 48. As seen in FIG. 10, the cord 48 is not directed to a specific location, because it could be plugged into the backpack, or it could hold line voltage and be plugged into a standard electrical outlet.

If the tool 10 is to be battery powered, then an extension cord extending from the battery pack could be provided to plug into a separate battery charger. An artisan working on a roof could have four sets of battery packs, for example, in which each pack might operate for 30-60 minutes before the batteries become discharged. The packs not in use could be undergoing a charging cycle while this occurs, and the user would always have a fully charged battery available for use.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

The invention claimed is:

1. A method for operating an induction heating apparatus, said method comprising:
(a) providing a unitary induction heating apparatus, which comprises: (i) an electrical power supply, (ii) a controller, (iii) an induction coil, (iv) a base portion which includes a mechanical guide structure, and (v) a longitudinal member that is placed between a first portion and a second portion of said unitary induction heating apparatus, said longitudinal member including an attachment device;
wherein:
said first portion includes at least one of said electrical power supply and said controller, and
said second portion includes at least one of said induction coil and said base portion;
(b) temporarily attaching said induction heating apparatus to an arm of a human user, in which said attachment device of the longitudinal member is placed in physical communication with said human arm;
(c) placing said human user with said attached induction heating apparatus atop a membrane roof structure under construction, said membrane roof structure including a lower substrate, a plurality of thermally insulative members, a plurality of attachment members, and an upper membrane structure, wherein: (i) said plurality of attachment members are at least partially electrically conductive, and (ii) a layer of thermally-activated adhesive material is affixed to an upper surface of said plurality of attachment members;
wherein:
said second portion extends at least somewhat downward toward said membrane roof structure under construction, and
said first portion extends at least somewhat upward away from said membrane roof structure under construction;
(d) placing a fastener portion of said plurality of attachment members through said plurality of thermally insulative members, and into said lower substrate, thereby attaching said plurality of thermally insulative members to said lower substrate;
(e) placing said upper membrane structure atop said plurality of thermally insulative members, and atop said plurality of attachment members;
(f) placing said base portion of the induction heating apparatus above said membrane surface, and mechanically locating at least one of said plurality of attachment members using said mechanical guide structure of said base portion, while said user of the induction heating apparatus operates in a standing position; and
(g) energizing said electrical power supply and said induction coil, thereby emitting a magnetic field from said induction coil, raising a temperature of at least one of said plurality of attachment members, and thereby raising a temperature of said thermally-activated adhesive material such that said thermally-activated adhesive material adheres to a bottom surface of said upper membrane structure, while said user of the induction heating apparatus remains in a standing position.

2. The method as recited in claim 1, wherein said mechanical guide is of a size and shape to assist in positioning said induction heating apparatus proximal to one of said attachment members.

3. The method as recited in claim 1, wherein said mechanical guide structure comprises a protrusion that extends around a bottom surface of the base portion, proximal to an outer perimeter of said bottom surface.

4. The method as recited in claim 3, wherein said mechanical guide structure acts as a runner that slides between a plurality of said attachment members, along an upper surface of said upper membrane structure.

5. The method as recited in claim 3, wherein said mechanical guide structure provides a positive feel to said user when said protrusion substantially surrounds one of said attachment members, as the induction heating apparatus is positioned proximal to that attachment member, while above said membrane surface.

6. The method as recited in claim 1, wherein said induction coil comprises a triple racetrack configuration.

7. The method as recited in claim 6, further comprising the steps of:
(a) during operation of said induction coil, emitting said magnetic field in a manner that requires said attachment member to be positioned within a first range of locations in a first direction, as a first tolerance, to be appropriately heated by said magnetic field; and
(b) during operation of said induction coil, emitting said magnetic field in a manner that requires said attachment member to be positioned within a second range of locations in a second direction, as a second tolerance, to be appropriately heated by said magnetic field, in which said first and second directions are substantially perpendicular to one another, along a surface of said upper membrane structure of the membrane roof structure under construction;
wherein: said triple racetrack configuration of the induction coil provides a substantially uniform value for both said first and second tolerances.

8. The method as recited in claim 6, wherein said base portion includes a heat spreader structure that is in thermal communication with said induction coil, wherein said heat spreader structure acts to more uniformly distribute thermal energy being produced in the induction coil in an effort to maximize thermal energy dissipation.

9. An induction heating apparatus, comprising:
(a) a lower base portion, (b) an upper body portion, and (c) a handle portion located therebetween;
(d) an electrical power supply and a controller;
(e) a manually-operable actuation device located in said handle portion;
(f) an attachment device located in said handle portion for releasably attaching said handle portion to an arm of a human user;
(g) an induction coil located in said base portion; and
(h) a mechanical guide structure located along a bottom surface of said base portion, said mechanical guide structure being of a size and shape to assist in positioning said induction heating apparatus proximal to an attachment member used in a membrane roof structure;
wherein said upper body portion includes at least one of said electrical power supply and said controller.

10. The induction heating apparatus as recited in claim 9, wherein when said manually-operable actuation device is operated by a user, said induction coil emits a magnetic field that induces eddy currents in an electrically conductive portion of said attachment member.

11. The induction heating apparatus as recited in claim 9, wherein said mechanical guide structure comprises a protrusion that extends around said bottom surface of the base portion, proximal to an outer perimeter of said bottom surface.

12. The induction heating apparatus as recited in claim 11, wherein said mechanical guide structure provides a positive feel to said user when said protrusion substantially surrounds one of a plurality of said attachment members as the induction heating apparatus is positioned proximal to that attachment member, while above said membrane roof structure.

13. The induction heating apparatus as recited in claim 9, further comprising an articulated joint between said handle and said lower base portion.

14. The induction heating apparatus as recited in claim 13, wherein said induction coil is of a triple racetrack configuration, which provides a substantially uniform value for operating positional tolerance in two horizontal orthogonal directions.

15. The induction heating apparatus as recited in claim 9, further comprising a heat spreader structure that is in thermal communication with said induction coil, wherein said heat spreader structure acts to more uniformly distribute thermal energy being produced in the induction coil in an effort to maximize thermal energy dissipation.

16. An induction heating apparatus, comprising:
(a) a lower base portion, (b) an upper body portion, and (c) a handle portion located therebetween;
(d) an electrical power supply and a controller, at least one of which is located in said upper body portion;
(e) a manually-operable actuation device located in said handle portion;
(f) an induction coil located in said lower base portion; and
(g) a plurality of heat sink elements located on a surface of said lower base portion.

17. The induction heating apparatus as recited in claim 16, wherein said plurality of heat sink elements comprise one of: (a) individual pin heat sinks that are substantially vertically mounted on an upper surface of said base portion; and (b) at least one heat sink having multiple fins, mounted on an upper surface of said base portion.

18. The induction heating apparatus as recited in claim 16, further comprising a base portion housing that covers said plurality of heat sink elements, wherein said base portion housing has a plurality of slots to allow ambient air to flow to said plurality of heat sink elements.

19. The induction heating apparatus as recited in claim 16, further comprising a body portion housing that covers said electrical power supply and said controller, wherein said body portion housing is of weatherproof construction.

20. The induction heating apparatus as recited in claim 19, further comprising a second plurality of heat sink elements that are located on a surface of said body portion housing.

21. The induction heating apparatus as recited in claim 16, wherein when said manually-operable actuation device is operated by a user, said induction coil emits a magnetic field that induces eddy currents in an electrically conductive portion of a susceptor.

22. The induction heating apparatus as recited in claim 21, wherein said susceptor comprises an attachment member used in a membrane roof structure.

23. The induction heating apparatus as recited in claim 22, further comprising: a mechanical guide structure located along a bottom surface of said base portion, said mechanical guide structure being of a size and shape to assist in positioning said induction heating apparatus proximal to said attachment member.

24. The induction heating apparatus as recited in claim 16, wherein said induction coil is of a triple racetrack configuration.

25. The induction heating apparatus as recited in claim 16, further comprising a heat spreader structure that is in thermal communication with said induction coil, wherein said heat spreader structure acts to more uniformly distribute thermal energy being produced in the induction coil in an effort to maximize thermal energy dissipation.

26. The induction heating apparatus as recited in claim 16, further comprising an articulated joint between said handle and said lower base portion.

27. An induction heating apparatus, comprising:
(a) a lower base portion, (b) an upper body portion, and (c) a handle portion located therebetween;
(d) an electrical power supply and a controller, at least one of which is located in said upper body portion;
(e) a manually-operable actuation device located in said handle portion;
(f) an induction coil located in said lower base portion; and
(g) at least one temperature sensor located near a bottom area of said lower base portion.

28. The induction heating apparatus as recited in claim 27, wherein said at least one temperature sensor is used to test an effect of the magnetic field being generated by the induction coil to determine if a membrane layer used in a membrane roof structure has been sufficiently heated by application of said magnetic field to a susceptor positioned beneath said membrane layer.

29. The induction heating apparatus as recited in claim 28, wherein said at least one temperature sensor comprises one of: (a) a non-contact device that determines temperature of a surface that is spaced-apart from said at least one temperature sensor; and (b) a contact device that is brought into physical contact with said surface.

30. The induction heating apparatus as recited in claim 29, wherein: (a) said non-contact device utilizes infrared detecting technology; and (b) said contact device includes a spring-loaded extension that makes physical contact with said surface.

31. The induction heating apparatus as recited in claim 28, wherein said controller of the induction heating apparatus uses a signal provided by said at least one temperature sensor to allow said induction heating apparatus to operate in a fully automatic mode, such that a drive current for said induction coil is periodically varied, according to variations in ambient temperature, as determined from said signal.
